(19) United States
(12) Patent Application Publication
(10) Pub. No.: US 2011/0297725 A1
(43) Pub. Date: Dec. 8, 2011

(54) STAPLE GUN

(76) Inventor: CHIEN CHUAN HUANG, Chang Hua City (TW)

(21) Appl. No.: 12/796,218

(22) Filed: Jun. 8, 2010

(51) Int. Cl. B25C 5/11

(52) U.S. Cl. 227/120; 227/140

(57) ABSTRACT

A staple gun includes an arm having an elongate hole and a protrusion extends from the first end of the arm. A driving plate has a first hole and a second hole. The protrusion is inserted into the first hole. A strike plate is located beside the driving plate and has a third hole. A resilient plate has a first end extending through the second hole and the third hole. A spring is rested on a top of the first end of the arm. A case includes a fulcrum axle and a fixed axle. The fulcrum axle extends through the elongate hole of the arm and is located behind the driving plate. The fixed axle contacts a top surface of the resilient plate. The effort arm from the fulcrum axle to the front end of the arm is shortened so as to save effort when pivoting the arm.

### FIELD OF THE INVENTION

The present invention relates to a staple gun, and more particularly, to a staple gun using lever principle to generate a significant force to staple the documents and to save the user's effort.

### BACKGROUND OF THE INVENTION

A conventional staple gun 7 is shown in FIG. 6 and generally includes case 71 in which a holding hole 711 is defined so that the users can hold the staple gun 7 by the holding hole 711. A magazine 712 is connected to the underside of the case 71 and staples are received in the magazine 712. The case 71 has a slot 72 defined in a front end thereof and a strike plate 73 is located in the slot 72. A resilient plate 74 is located in the case 71 and the front end of the resilient plate 74 is engaged with the strike plate 73. A Fixed axle 75 of the case 71 extends through an arm 76 which is pivotably connected to the front end of the case 71. The front end of the arm 76 is hooked to the strike plate 73 and a spring 78 is located between the front end of the arm 76 and the inside of the case 71. The arm 76 is pivoted about the fulcrum axle 77 and the spring 78 keeps the arm 76 at the initial position when the user releases the arm 76. When the user holds the case 71 via the holding hole 711 and applies a force “P” at the rear end of the arm 76, and pivots the arm 76 downward which is pivoted about the fulcrum axle 77. The effort arm “A” is the distance from the point where the force “P” is applied on the arm 76 to the fulcrum axle 77. The front end of the arm 76 is pivoted upward so that the strike plate 73 moves upward in the slot 72. The effort arm “B” is the distance from the fulcrum axle 77 to the point where the arm 76 is engaged with the strike plate 73. The resilient plate 74 and the strike plate 73 are both moved upward. The front end of the resilient plate 74 bends upward to store a force therein. Because the rear end of resilient plate 74 is fixed to the case 71 and the resilient plate 74 is bent about the fixed axle 75, the effort arm “C” is the distance from the rear end of the resilient plate 74 to the hooked position of the resilient plate 74 to the strike plate 73. The effort arm “D” is the distance from the fixed axle 75 to the rear end of the resilient plate 74. The arm 76 is continuously pivoted downward, and the force applies to the arm 76 is larger than the force of the bent portion of the resilient plate 74, the front end of the arm 76 is Finally disengaged from the strike plate 73, the stored force of the bent portion of the resilient plate 74 is ejects the staple in the magazine 712 to staple document. According to the lever principle, when the distances of the effort arms “A” and “C” are way longer than the distances of the effort arms “B” and “D”, the user saves effort to operate the arm 76 to move the strike plate 73 to finish the stapling process.

However, although the user saves effort to operate the arm 76 when the distances of the effort arms “A” and “C” are way longer than the distances of the effort arms “B” and “D”, the resilient plate 74 generates significant vibration and the vibration often makes the user uncomfortable and has to hold the staple gun 7 firmly.

### SUMMARY OF THE INVENTION

The present invention relates to a staple gun and the staple gun comprises an arm having an elongate hole defined in a first end thereof and a protrusion extends from the first end of the arm. A driving plate has a first hole and a second hole which is located below the first hole. The protrusion of the arm is inserted into the first hole. A strike plate is located beside the driving plate and has a third hole. A resilient plate has a first end extending through the second hole of the driving plate and the third hole of the strike plate. A spring is rested on a top of the first end of the arm. A case has a fulcrum axle and a fixed axle, wherein the fulcrum axle extends through the elongate hole of the arm and the driving plate is located between the fixed axle and the strike plate. The fixed axle contacts a top surface of the resilient plate.

The primary object of the present invention is to provide a staple gun wherein the effort arm from the fixed axle to the front end of' the arm is shortened such that the arm is easily pivoted downward when compared with the conventional staple gun. The resilient plate is bent to generate a significant force to eject the staples.

The present invention further provides a staple gun wherein the position of the fulcrum for the resilient plate is adjustable to meet different needs of staples of different lengths.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the staple gun of the present invention;

FIG. 2 is a perspective view to show the staple gun of the present invention;

FIG. 3 is a side view to show the distances of the effort arms of the staple gun of the present invention;

FIG. 4 is a side view to show that the arm is pivoted downward;

FIG. 5 shows that the semi-circular surface of the adjustment knob is rotated to contact the top surface of the resilient plate, and

FIG. 6 is a side view to show a conventional staple gun.

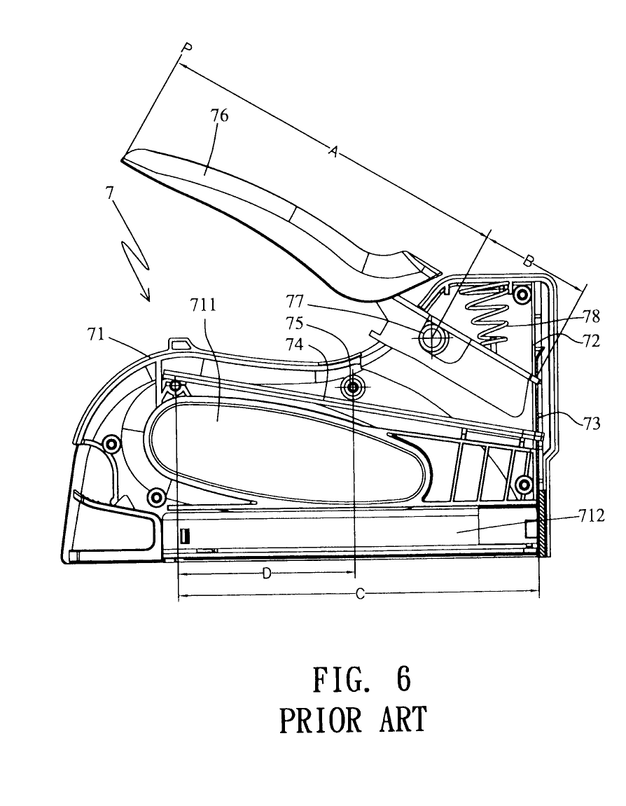

### DETAILED DESCRIPTION OF THE PREFERRED EMBODIMENT

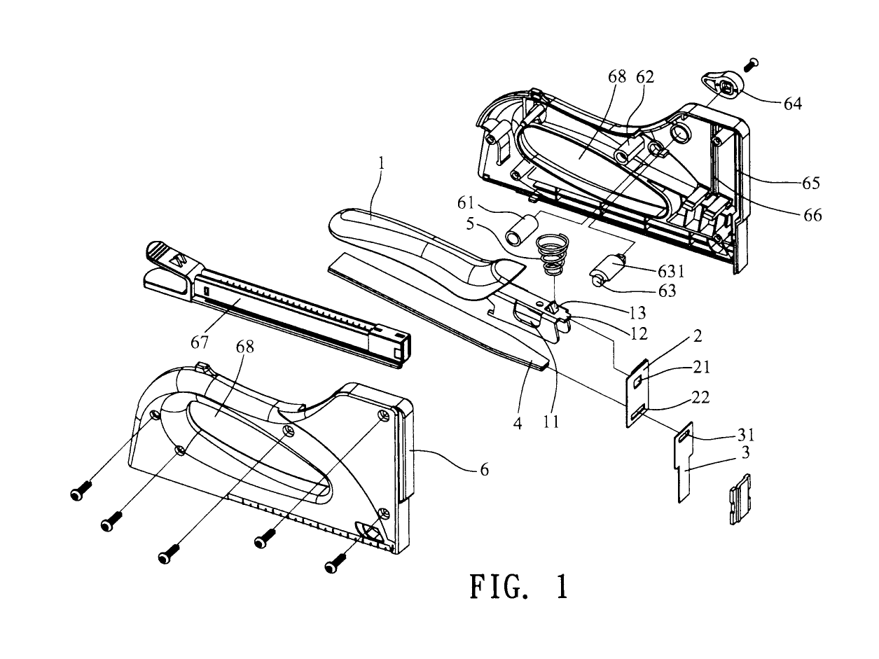

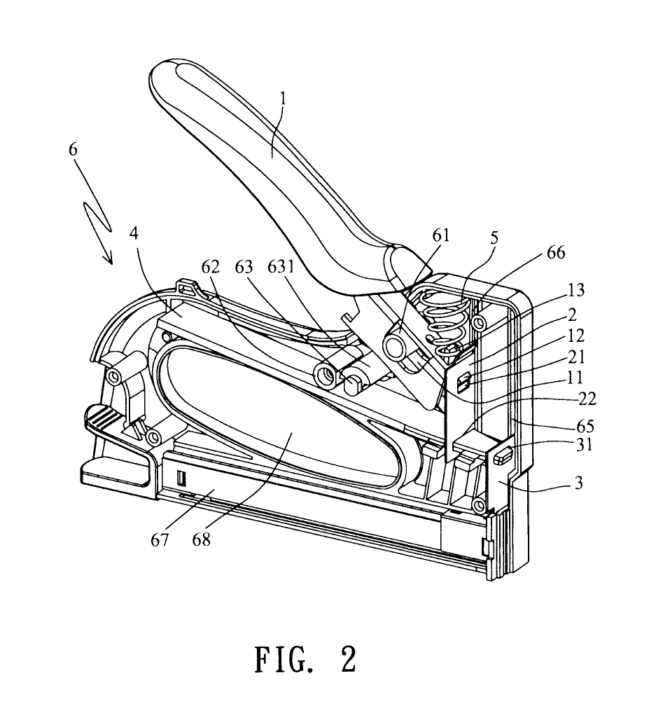

Referring to FIGS. 1 and 2, the staple gun of the present invention comprises an arm 1 which has an elongate hole 11 defined in a first end thereof and a protrusion 12 extends from the first end of the arm 1. A top block 13 is located on the top of the first end of the arm 1.

A driving plate 2 has a first hole 21 and a second hole 22 which is located below the first hole 21. The protrusion 12 of the arm 1 is inserted into the first hole 21.

A strike plate 3 is located beside (in front of) the driving plate 2 and has a third hole 31.

A resilient plate 4 has a first end extending through the second hole 22 of the driving plate 2 and the third hole 31 of the strike plate 3.

A spring 5 is rested on the top block 13 on the top of the first end of the arm 1.

A case 6 includes a fulcrum axle 61, a fixed axle 62, an adjustment axle 63, an adjustment knob 64, a first slot 65, a second slot 66, a magazine 67, and a holding hole 68. The fulcrum axle 61 extends through the elongate hole 11 of the arm 1 and the driving plate 2 is located between the fixed axle 62 and the strike plate 3. The fixed axle 62 contacts a top surface of the resilient plate 4. The adjustment axle 63 and the adjustment knob 64 are connected and located between the fulcrum axle 61 and the driving plate 2. The adjustment axle 63 includes a semi-circular contact surface 631 which can be rotated to contact against the top surface of the resilient plate 4 to change the fulcrum of the resilient plate 4. The fulcrum axle 61 is located at a front end of the case 6 and the fulcrum axle 61 is located closer to the front end of the case 6 than the fixed axle 62 is located. The first slot 65 is located in the front end of the case 6 and the strike plate 3 is located in the first slot 65. The second slot 66 is located behind the first slot 65 and the driving plate 2 is located in the second slot 66. The magazine 67 is connected to the underside of the case 6. The holding hole 68 is defined through the case 6 and the user's hand can extend through the holding hole 68 to hold the case 6.

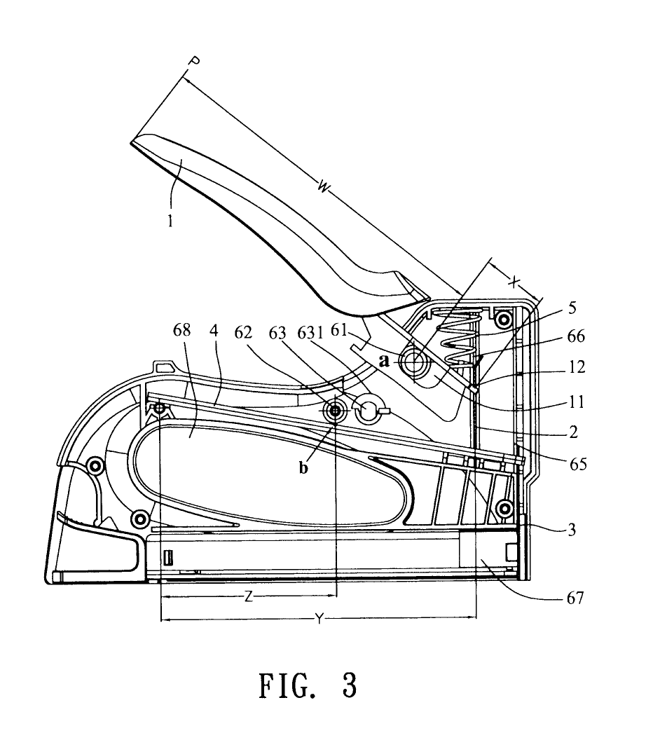

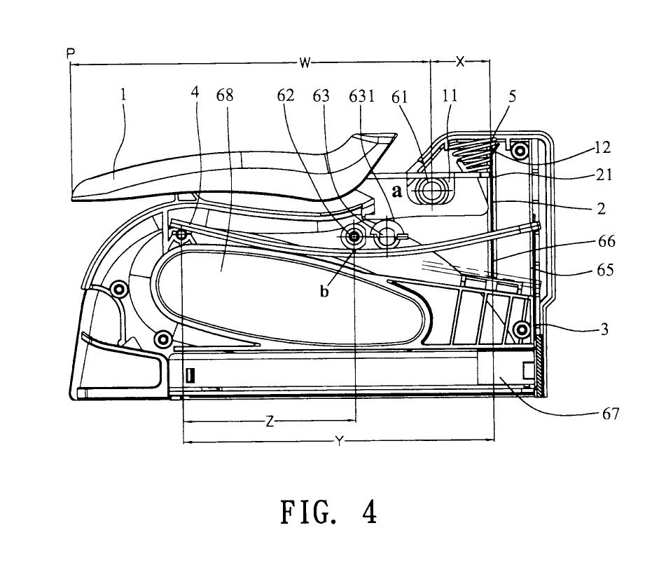

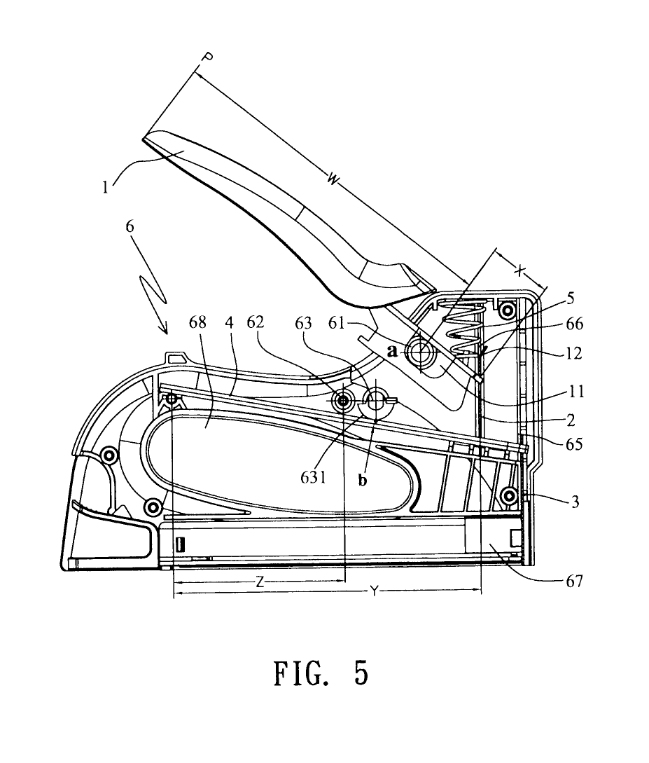

Referring to FIGS. 3 and 4, when the user holds the case 6 and pivots the arm 1 downward, the arm 1 is pivoted about the first fulcrum “a” on the fulcrum axle 61. The effort arm “W” is the distance from the point “P” where the force is applied to the arm 1 to the fulcrum axle 61. The protrusion 12 moves upward to lift the driving plate 2 in the second slot 66. The spring 5 is compressed by the first end of the arm 1. The effort arm “X” is the distance from the fulcrum “A” to the protrusion 12. The first end of the resilient plate 4 extends through the second hole 22 in the driving plate 2, so that the first end of the resilient plate 4 is bent about a second fulcrum “b” on the fixed axle 62 to store a force. For the resilient plate 4, the effort arm “Y” is the distance from the driving plate 2 to the second end of the resilient plate 4, wherein the second end of the resilient plate 4 is fixed to the case 6. The effort arm “Z” is the distance from the fixed axle 62 to the second end of the resilient plate 4. The strike plate 3 is lifted in the first slot 65 by the resilient plate 4. When the user continuously pivots the arm 1 downward, and the force that is applied to the arm 1 by the user is larger than the force of the bending of the resilient plate 4, the protrusion 12 of the arm 1 is finally disengaged from the first hole 21 of the driving plate 2. The first end of the resilient plate 4 generates a significant force to move the strike plate 3 downward to eject the staple (not shown) out from the magazine 67. According the lever principle, when the distances of the “W” and “Y” are way longer than those of “X” and “Z”, cooperated with the movement of the driving plate 2, the distance of the effort arm “X” is shortened while the travel of the strike plate 3 is not changed. The user uses less force to operate the arm 1 to finish the stapling process. When the arm 1 is released, the spring 5 pivots the arm 1 and the protrusion 12 is again engaged with the first hole 21 of the driving plate 2. Referring to FIG. 5, when rotating the adjustment knob 64, the adjustment axle 63 is co-rotated, and the semi-circular contact surface 631 is rotated to contact against the top surface of the resilient plate 4 to change the fulcrum of the resilient plate 4 from the fixed axle 62 to the fulcrum “b” on the adjustment axle 63. Although the arm 1 may be harder to be pivoted, but the force that output can be adjusted so as to meet the requirements of the staples of different sizes and lengths.

While we have shown and described the embodiment in accordance with the present invention, it should he clear to those skilled in the art that further embodiments may be made without departing from the scope of the present invention.

What is claimed is:

1. A staple gun comprising:
an arm having an elongate hole defined in a first end thereof and a protrusion extending from the First end of the arm;
a driving plate having a first hole and a second hole which is located below the first hole, the protrusion of the arm inserted into the first hole;
a strike plate located beside the driving plate and having a third hole;
a resilient plate having a first end extending through the second hole of the driving plate and the third hole of the strike plate;
a spring rested on a top of the first end of the arm, and
a case having a fulcrum axle and a fixed axle, the fulcrum axle extending through the elongate hole of the arm and the driving plate located between the fixed axle and the strike plate, the fixed axle contacting a top surface of the resilient plate.

2. The staple gun as claimed in claim 1, wherein a top block is located on the top of the first end of the arm and the spring is mounted on the top block.

3. The staple gun as claimed in claim 2, wherein the fulcrum axle is located at a front end of the case.

4. The staple gun as claimed in claim 3, wherein the fulcrum axle is located closer to the front end of the case than the fixed axle is located.

5. The staple gun as claimed in claim 4, wherein the case comprises an adjustment axle and an adjustment knob, the adjustment axle and the adjustment knob are located between the fulcrum axle and the driving plate.

6. The staple gun as claimed in claim 5, wherein the adjustment axle includes a semi-circular contact surface which contacts against the top surface of the resilient plate.

7. The staple gun as claimed in claim 1, wherein the case includes a first slot which is located in the front end of the case.

8. The staple gun as claimed in claim 7, wherein the case includes a second slot which is located behind the first slot and the driving plate is located in the second slot.

9. The staple gun as claimed in claim 1, wherein the case has a magazine connected to the underside thereof.

10. The staple gun as claimed in claim 1, wherein the case has a holding hole defined therethrough.
